(19) United States
(12) Patent Application Publication
(10) Pub. No.: US 2005/0089169 A1
(43) Pub. Date: Apr. 28, 2005

(54) Encryption and communication apparatus and method using modulated delay time feedback chaotic system

(75) Inventors: Chil Min Kim, Daejeon City (KR); Won Ho Kye, Daejeon City (KR)

Correspondence Address: GREENBLUM & BERNSTEIN, P.L.C., 1950 ROLAND CLARKE PLACE, RESTON, VA, 20191, US

(73) Assignee: Educational Corporation PAI CHAI HAK DANG, Daejeon (KR)

(21) Appl. No.: 10/780,565

(22) Filed: Feb. 19, 2004

(30) Foreign Application Priority Data
Oct. 23, 2003 (KR) 10-2003-0074183

(51) Int. Cl. H04L 9/00

(52) U.S. Cl. 380/263

(57) ABSTRACT

Disclosed herein is an encryption and communication apparatus and method using a modulated delay time feedback chaotic system. The encryption apparatus of the present invention includes chaotic signal generating means for generating a high-dimensional chaotic signal in response to an original chaotic signal and a predetermined feedback chaotic signal, delay time modulating means for delaying the high-dimensional chaotic signal output from the chaotic signal generating means by a predetermined time and modulating the time-delayed chaotic signal, and feedback means for receiving the chaotic signal output from the chaotic signal generating means and the modulated time-delayed signal output from the delay time modulating means, performing addition and subtraction operations with respect to the received signals, and feeding the operated result back to the chaotic signal generating means. Accordingly, the present invention is advantageous in that it modulates a delay time so as to prevent an information signal contained in a chaotic signal from being attacked from the outside, so that it is impossible to detect an exact delay time contained in a modulated time-delayed chaotic signal and to decrypt the information signal, thus constructing a more robust and reliable encryption system.

### BACKGROUND OF THE INVENTION

1. Field of the Invention

The present invention relates, in general, to an encryption apparatus using a chaotic system and, more particularly, to an encryption and communication apparatus and method using a modulated delay time feedback chaotic system, which encrypts data using a chaotic system for generating a more complicated chaotic signal, thus securely communicating data.

2. Description of the Related Art

Recently, research on the chaos theory, which is applied to various industry fields, has been actively carried out.

Chaotic signal generated from apparatuses generating chaotic signal is sensitive to initial conditions. Therefore, the respective chaotic signal generated from two chaotic signal generating apparatuses, which are actually the same, greatly vary with the evolve of time even if initial conditions only slightly differ, thus rapidly varying along different trajectories and values almost irrelevant to each other. That is, as time evolves, the chaotic signal generating apparatuses become non-periodic and unpredictable. Such behavior of the chaotic signal generating apparatuses is due to the characteristic of being sensitive to initial conditions, called the butterfly effect.

The synchronization of the chaotic systems means that the state variables of respective chaotic signal generating apparatuses become identical in a chaotic system comprised of two or more equal chaotic signal generating apparatuses having various status variables to control chaotic behavior. Technology related to such synchronization of the chaotic systems can be applied to various industry fields, especially, more suitably applied to communications requiring security.

However, there have been recently addressed many questions about the chaotic system, which can be suitably used for secure communication using chaos synchronization. In the case where a chaotic system is of lower dimensions, schemes capable of searching chaotic signals for an information signal using chaos prediction or feedback modeling have been developed.

Therefore, a high-dimensional chaotic system has been proposed as an efficient system. In this case, if the high-dimensional chaotic system is used for an encryption system, it takes much time to analyze high-dimensional chaos, so that the high-dimensional chaotic system can be used for an efficient encryption system. Therefore, in order to easily generate high-dimensional chaos, a chaotic system using time-delay feedback has been proposed.

However, it was disclosed that such a high-dimensional chaotic system using the time-delay feedback has problems. That is, if a time-delayed chaotic signal is analyzed, delay time information can be detected, and if the delay time is detected, the high-dimensional chaotic system can be lowered to a low-dimensional chaotic system, so that an information signal contained in a chaotic signal can be attacked by an eavesdropper and leaked to the outside.

### SUMMARY OF THE INVENTION

Accordingly, the present invention has been made keeping in mind the above problems occurring in the prior art, and an object of the present invention is to provide an encryption and communication apparatus and method using a modulated delay time feedback chaotic system, which modulates a delay time so as to prevent an information signal contained in a chaotic signal from being attacked from outside, so that it is impossible to detect an exact delay time included in the modulated delay time feedback chaotic signal because the delay time is modulated in a delay time feedback chaotic signal, thus constructing a robust encryption system.

Another object of the present invention is to provide a an encryption and communication apparatus and method using a modulated delay time feedback chaotic system, in which the delay time of the time-delayed chaotic signal is modulated, so that it is impossible to detect an exact delay time included in the time-delayed chaotic signal, thus constructing a more robust encryption system.

In order to accomplish the above object, the present invention provides an encryption apparatus using a modulated delay time feedback chaotic system, comprising chaotic signal generating means for generating a high-dimensional chaotic signal in response to an original chaotic signal and a predetermined feedback chaotic signal; time delaying means for delaying the chaotic signal output from the chaotic signal generating means by a predetermined time and outputting a time-delayed chaotic signal; delay time modulating means for modulating the time-delayed chaotic signal; and feedback means for receiving the chaotic signal output from the chaotic signal generating means and the modulated time-delayed signal output from the delay time modulating means, performing addition and subtraction operations with respect to the received signals, and feeding the operated result back to the chaotic signal generating means.

Further, the present invention provides an encryption and communication apparatus using a modulated delay time feedback chaotic system, comprising an encryption apparatus including first chaotic signal generating means for generating a high-dimensional chaotic signal in response to a predetermined feedback chaotic signal, delay time modulating means for delaying the chaotic signal output from the first chaotic signal generating means by a predetermined time and modulating the time-delayed chaotic signal to generate a high-dimensional encryption signal, feedback means for receiving the chaotic signal output from the first chaotic signal generating means and the modulated time-delayed chaotic signal output from the delay time modulating means, performing addition and subtraction operations with respect to the two received signals and feeding the operated result back to the first chaotic signal generating means, encryption means for receiving the high-dimensional encryption signal output from the delay time modulating means and an externally-applied information signal and adding the two signals to realize encryption, and transmitting means for transmitting a signal output from the encryption means as a wireless or wired signal; and a decryption apparatus including an receiving means for receiving the encryption signal from the transmitting means of the encryption apparatus, second chaotic signal generating means for generating a high-dimensional chaotic signal in response to a predetermined feedback chaotic signal, feedback means for receiving the encryption signal output from the receiving means and the chaotic signal output from the second chaotic signal generating means, performing addition and subtraction operations with respect to the two received signals and feeding the operated result back to the second chaotic signal generating means, delay time modulating means for receiving the chaotic signal output from the second chaotic signal generating means and modulating a delay time of the chaotic signal, and decryption means for performing a subtraction operation on the modulated time-delayed signal output from the delay time modulating means and the encryption signal output from the receiving means to realize decryption.

Further, the present invention provides an encryption and communication method using a modulated delay time feedback chaotic system, comprising the steps of generating a chaotic signal by a chaotic system in which variables are functionally connected and a delay time is modulated; encrypting an externally-applied information signal by adding the information signal to the chaotic signal, the delay time of which is modulated, thus generating an encryption signal; transmitting the encryption signal; receiving the encryption signal and feeding the encryption signal to a predetermined chaotic system; receiving the chaotic signal output from the chaotic system and modulating a delay time of the chaotic signal; and comparing the modulated time-delayed chaotic signal to the received encryption signal and then extracting the information signal, thus decrypting the encryption signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an encryption apparatus using a modulated delay time feedback chaotic system according to the present invention;

FIG. 2 is a block diagram of an encryption and communication apparatus using a modulated delay time feedback chaotic system according to an embodiment of the present invention;

FIGS. 3a to 3c are views showing delay time information appearing in the autocorrelation of a logistic map according to the present invention;

FIGS. 4a and 4b are views showing the shapes of chaotic attractors obtained through modulated delay time feedback in a Lorenz chaotic system according to the present invention;

FIGS. 5a and 5b are views showing delay time information appearing in the autocorrelation of the Lorenz chaotic system according to the present invention;

FIGS. 6a and 6b are views showing transverse Lyapunov exponents of two Lorenz chaotic systems according to the present invention;

FIG. 7 is a view showing a region in which the two Lorenz chaotic systems are synchronized according to the present invention; and

FIGS. 8a to 8c are views showing the behavior in which the two Lorenz chaotic systems are synchronized according to the present invention.

### DESCRIPTION OF THE PREFERRED EMBODIMENTS

Hereinafter, embodiments of the present invention will be described in detail with reference to the attached drawings.

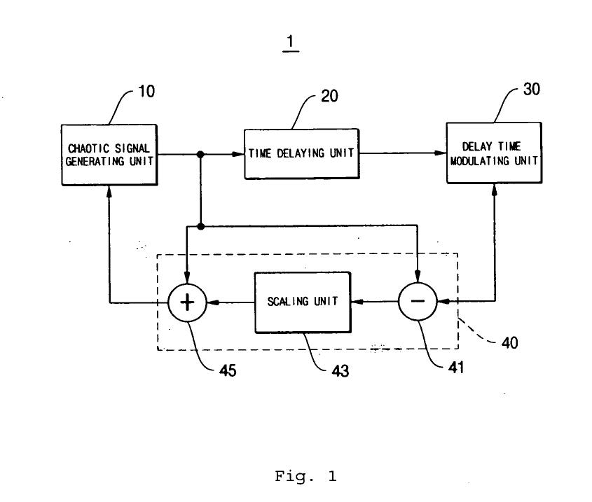

FIG. 1 is a block diagram of an encryption apparatus using a modulated delay time feedback chaotic system according to the present invention. The encryption apparatus includes a chaotic signal generating unit 10, a time delaying unit 20, a delay time modulating unit 30 and a feedback unit 40.

The chaotic signal generating unit 10 is constructed to generate a high-dimensional chaotic signal in response to an original chaotic signal and a predetermined feedback signal. The time delaying unit 20 is constructed to delay the chaotic signal output from the chaotic signal generating unit 10 by a predetermined time and output the time-delayed chaotic signal. The delay time modulating unit 30 is constructed to modulate the time-delayed chaotic signal output from the time delaying unit 20. The feedback unit 40 is constructed to receive the chaotic signal output from the chaotic signal generating apparatus 10 and the modulated time-delayed chaotic signal output from the delay time modulating unit 30, to perform addition and subtraction operations with respect to the received signals, and to feed the operated result back to the chaotic signal generating unit 10.

Further, the feedback unit 40 includes a subtracter 41 for receiving the original chaotic signal output from the chaotic signal generating unit 10 and the modulated time-delayed chaotic signal output from the delay time modulating unit 30 and obtaining a difference between the two received signals, a scaling unit 43 for scaling the magnitude of the difference signal output from the subtracter 41 to correspond to synchronization conditions, and an adder 45 for adding a signal output from the scaling unit 43 and the original chaotic signal output from the chaotic signal generating unit 10 to generate a predetermined chaotic signal and feeding the chaotic signal back to the chaotic signal generating unit 10.

That is, in a chaotic system 1 of the present invention, if an arbitrary one x(t) of a plurality of chaotic signals, which are generated by the chaotic signal generating unit 10 having functionally connected variables and generating chaotic signals, is delayed by a predetermined time τ using the time delaying unit 20, a predetermined time-delayed signal x(t−τ) is generated. A chaotic delay time of the time delaying unit 20 is modulated to a predetermined function τ=f(t) by the delay time modulating unit 30. The chaotic signal, the delay time of which is modulated by the delay time modulating unit 30, is processed in such a way that the subtracter 41 for obtaining a difference between the original chaotic signal and the modulated time-delayed chaotic signal obtains the difference x(t−τ)−x(t) therebetween. Thereafter, the scaling unit 43 scales a variable ε so that the magnitude of the signal output from the subtracter 41 becomes ε[x(t−τ)−x(t)] to correspond to synchronization conditions. Thereafter, the adder 45 generates a signal x(t)+ε[x(t−τ)−x(t)] by adding the original chaotic signal x(t) and the signal ε[x(t−τ)−x(t)] output from the scaling unit 43, and feeds the generated signal back to the chaotic signal generating unit 10.

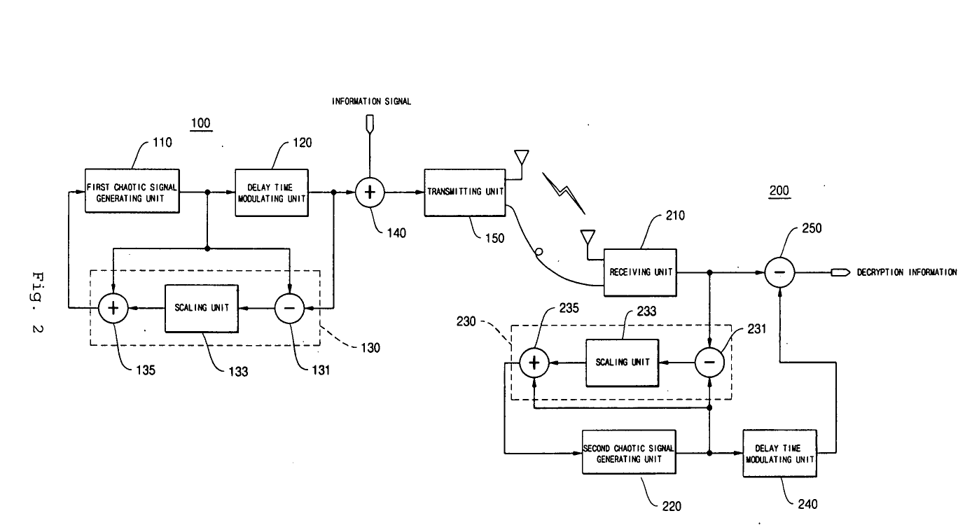

FIG. 2 is a circuit diagram of an encryption and communication apparatus using a modulated delay time feedback chaotic system according to an embodiment of the present invention, in which an encryption apparatus 100 and a decryption apparatus 200 are depicted.

The encryption apparatus 100 includes a first chaotic signal generating unit 110 for generating a high-dimensional chaotic signal in response to a predetermined feedback chaos signal, a delay time modulating unit 120 for delaying the chaotic signal output from the first chaotic signal generating unit 100 by a predetermined time and modulating the time-delayed chaotic signal to generate a high-dimensional encryption signal, a feedback unit 130 for receiving the chaotic signal output from the first chaotic signal generating unit 110 and the modulated time-delayed chaotic signal output from the delay time modulating unit 120, performing addition and subtraction operations with respect to the two signals and feeding the operated result back to the first chaotic signal generating unit 110, an encryption means 140 for receiving the high-dimensional encryption signal output from the delay time modulating unit 120 and an externally applied information signal and adding the two signals to realize encryption, and a transmitting unit 150 for transmitting a signal output from the encryption means 140 as a wireless or wired signal.

The feedback unit 130 of the encryption apparatus 100 includes a subtracter 131 for receiving the original chaotic signal output from the first chaotic signal generating unit 110 and the modulated time-delayed chaotic signal output from the delay time modulating unit 120 and obtaining a difference between the two received signals, a scaling unit 133 for scaling the magnitude of the difference signal output from the subtracter 131 to correspond to synchronization conditions, and an adder 135 for adding a signal output from the scaling unit 133 and the original chaotic signal output from the first chaotic signal generating unit 110 to generate a predetermined chaotic signal and feeding the chaotic signal back to the first chaotic signal generating unit 110.

The decryption apparatus 200 includes a receiving unit 210 for receiving the encryption signal from the transmitting unit 150 of the encryption apparatus 100, a second chaotic signal generating unit 220 for generating a high-dimensional chaotic signal in response to a predetermined feedback chaotic signal, a feedback unit 230 for receiving the encryption signal output from the receiving unit 210 and the chaotic signal output from the second chaotic signal generating unit 220 and performing addition and subtraction operations with respect to the two received signals, and feeding the operated result back to the second chaotic signal generating unit 220, a delay time modulating unit 240 for receiving the chaotic signal generated by the second chaotic signal generating unit 220 and modulating the delay time of the chaotic signal, and a decryption means 250 for receiving the modulated time-delayed signal output from the delay time modulating unit 240 and the encryption signal output from the receiving unit 210, and performing a subtraction operation on the received signals to realize decryption.

Further, the feedback unit 230 of the decryption apparatus 200 includes a subtracter 231 for receiving the original chaotic signal output from the second chaotic signal generating unit 220 and the encryption signal output from the receiving unit 210 and obtaining a difference between the received signals, a scaling unit 233 for scaling the magnitude of the difference signal output from the subtracter 231 to correspond to synchronization conditions, and an adder 235 for adding a signal output from the scaling unit 233 and the original chaotic signal output from the second chaotic signal generating unit 220 to generate a predetermined chaotic signal and feeding the chaotic signal back to the second chaotic signal generating unit 220.

That is, the chaotic system is provided with the first and second chaotic signal generating units 110 and 220, which are the same. The encryption apparatus 100 provided with the first chaotic signal generating unit 110 is a device for encrypting an information signal, and the decryption apparatus 200 provided with the second chaotic signal generating unit 220 is a device for decrypting an encrypted information signal.

In the encryption apparatus 100, a delay time of a variable signal of the chaotic system is modulated by the delay time modulating unit 120 and then fed back to the first chaotic signal generating unit 110, thus generating the high-dimensional chaotic signal. A procedure of generating the high-dimensional chaotic signal is described below. That is, in the same manner as that of FIG. 1, a difference between a chaotic signal x(t−τ) obtained by modulating a delay time of a signal x(t) and the original chaotic signal is obtained by the subtracter 131. The difference is scaled by the scaling unit 133, and the scaled result is added to the original chaotic signal by the adder 135. The added result is fed back to the first chaotic signal generating unit 110 to generate a complicated chaotic signal.

Further, the encryption is carried out in such a way that both the modulated time-delayed chaotic signal, having passed through the delay time modulating unit 120, and the information signal pass through the encryption means 140, such as an adder or subtracter, to generate the encryption signal. The encryption signal is transmitted through the transmitting unit 150.

Further, in the decryption apparatus 200, in order to decrypt the encryption signal transmitted from the encryption apparatus 100, the encryption signal, received by the receiving unit 210, is fed back to the second chaotic signal generating unit 220 in the same manner as that of the first chaotic signal generating unit 110, thus synchronizing the second chaotic signal generating unit 220 with the first chaotic signal generating unit 110. A difference between the encryption signal received by the receiving unit 210 and the chaotic signal x′(t) generated by the second chaotic signal generating unit 220 is obtained by the subtracter 231 as x(t−τ)−x′(t). The magnitude of the signal x(t−τ)−x′(t) is scaled to ε[x(t−τ)−x′(t)] to correspond to synchronization conditions by the scaling unit 233. The scaled signal is added to the original chaotic signal output from the second chaotic signal generating unit 220 by the adder 235 to generate a signal x′(t)+ε[x(t−τ)−x′(t)], which is fed back to the second chaotic signal generating unit 220.

Further, the decryption is carried out in such a way that a decryption information signal into which the information signal is decrypted can be obtained through the decryption means 250, such as the subtracter for obtaining a difference between the modulated time-delayed chaotic signal, obtained by modulating the delay time of the chaotic signal generated by the second chaotic signal generating unit 220 in the same manner as that of the delay time modulating unit 120 of the encryption apparatus 100, and the encryption signal received from the receiving unit 210.

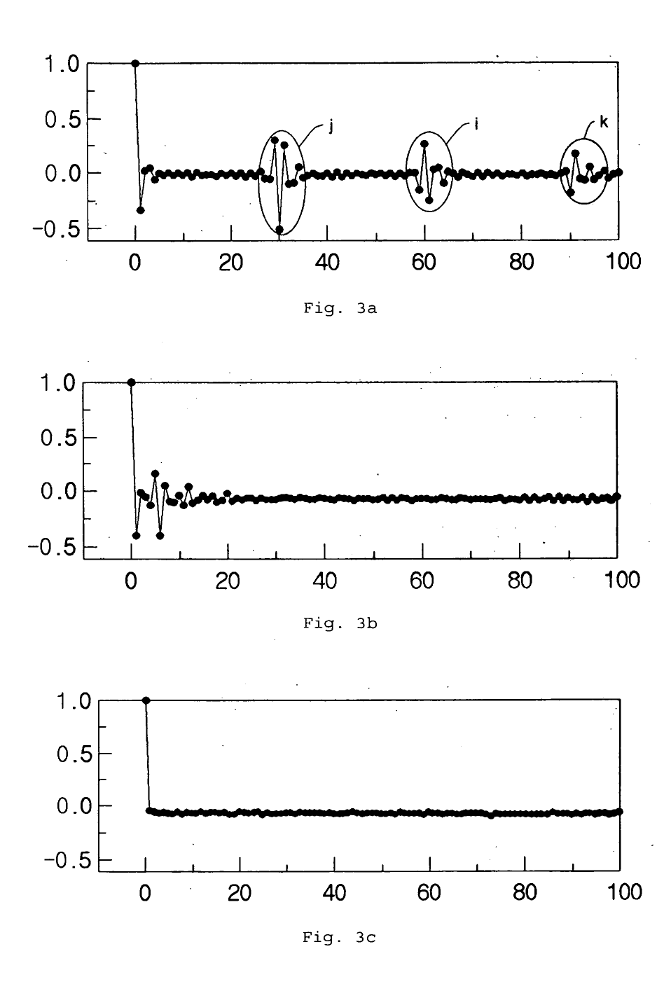

FIGS. 3a to 3c are views comparing autocorrelations emerging when the delay time is fixed and modulated, respectively, using a logistic map according to the present invention.

In accordance with the autocorrelations, it can be seen that, if the delay time τ is fixed to τ₀=30 as shown in FIG. 3a, delay time information appears as shown at positions \mathring{i}, \mathring{j} and \mathring{k} of FIG. 3a. If the above delay information is known, the high-dimensional chaotic information can be reduced to low-dimensional chaotic information even though the high-dimensional chaotic system is implemented using the delay time, thus detecting the information contained in the chaotic signal.

On the contrary, if the delay time τ is modulated to τ=(τ₀/2−1)sin(t)+τ₀/2 as shown in FIG. 3b, the delay time is mixed to a delay autocorrelation function and then disappears, so that the information on the delay time does not appear.

Due to the disappearance of the delay time, the delay information cannot be detected, thus increasing the degree of security.

Further, if the delay time is modulated to τ=(τ₀−1)ξ(t)+1 and ξ(t) is a random number as shown in FIG. 3c, the indications of the delay time information disappear, and a signal of the logistic map is changed to the random number. Therefore, if the delay time is modulated and encrypted using the modulated delay time feedback chaotic system, the security of information can be guaranteed.

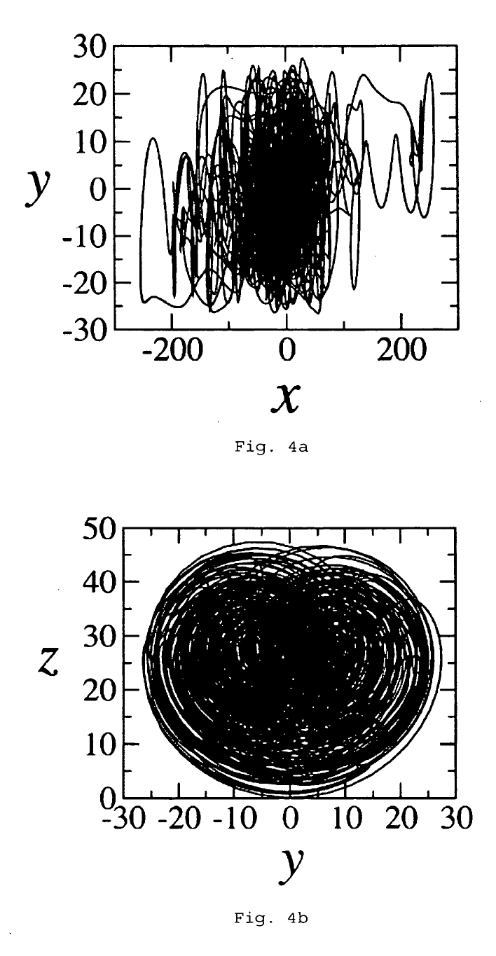

FIGS. 4a and 4b are views showing the shapes of chaotic attractors obtained when a delay time is modulated and then fed back using Lorenz equations.

In this case, the delay time is modulated to τ=0.457τ₀ sin(ωt)+τ₀/2. Further, (1−β)×(t)+β×(t−τ) is fed back to a Lorenz chaotic system x(t).

FIGS. 4a and 4b illustrate attractors where β=0.93 and ω=0.005. That is, both an attractor of x-y variables of FIG. 4a and an attractor of y-z variables of FIG. 4b do not have original chaotic attractors of the Lorenz chaotic system, thus showing that the attractors are complicated high-dimensional chaotic signals.

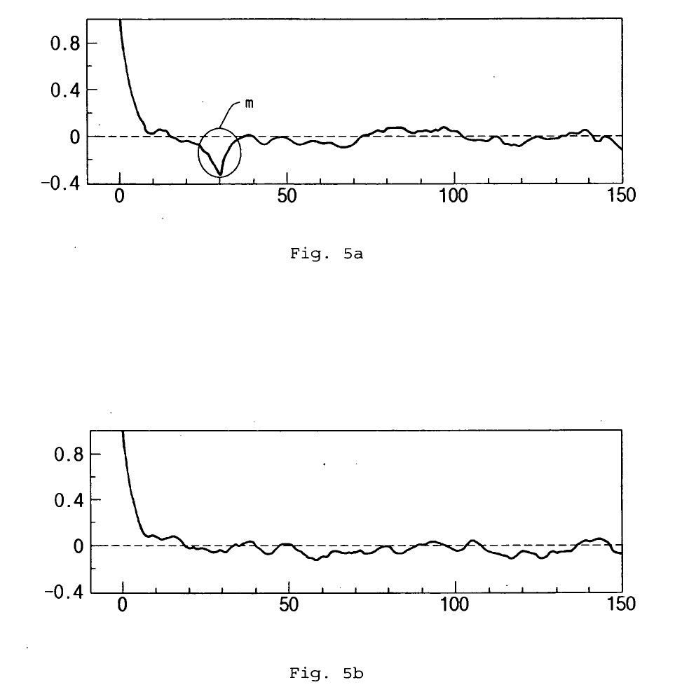

FIGS. 5a and 5b are views showing autocorrelations when two Lorenz chaotic systems are synchronized where β=0.92 and ω=0.005.

FIG. 5a shows that delay time information appears in the autocorrelation as it is as shown at a position \mathring{m} when the delay time is fixed, and FIG. 5b shows that delay time information disappears from the autocorrelation when the delay time is modulated. Referring to the autocorrelations, if the delay time is modulated and fed back, the delay time cannot be detected from outside, thus implementing a secure encryption system.

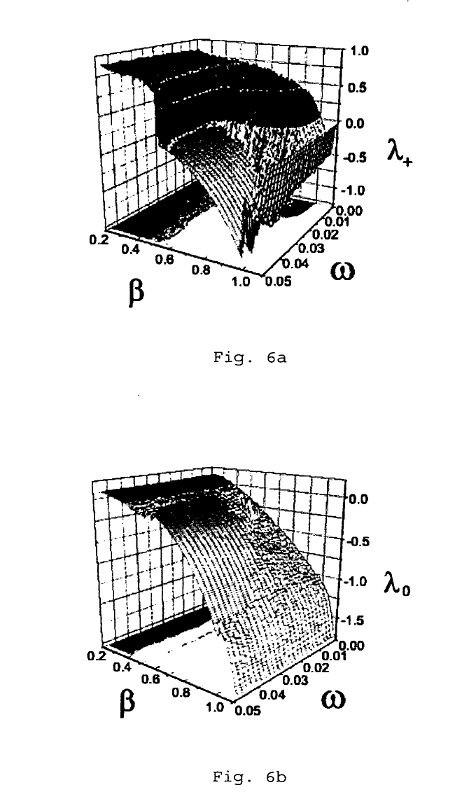

FIGS. 6a and 6b illustrate a maximum transverse Lyapunov exponent and a secondary transverse Lyapunov exponent obtained to show the synchronization of the two Lorenz chaotic systems when the two Lorenz chaotic systems are synchronized in the conditions of FIG. 5.

FIGS. 6a and 6b show Lyapunov exponents according to β and ω, in which a synchronization region with Lyapunov exponents having values equal to or less than “0” exists in each of the drawings.

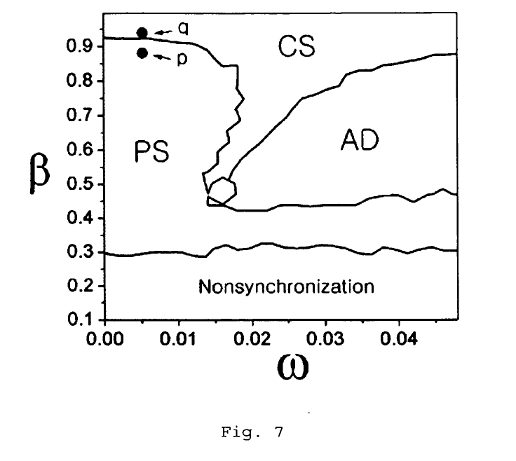

FIG. 7 illustrates a synchronization region appearing when two Lorenz chaotic systems are combined with each other, with the synchronization area being obtained according to β and ω.

Referring to FIG. 7, there is a region in which complete synchronization is realized to implement an encryption system. In FIG. 7, a region “CS” represents the synchronization region.

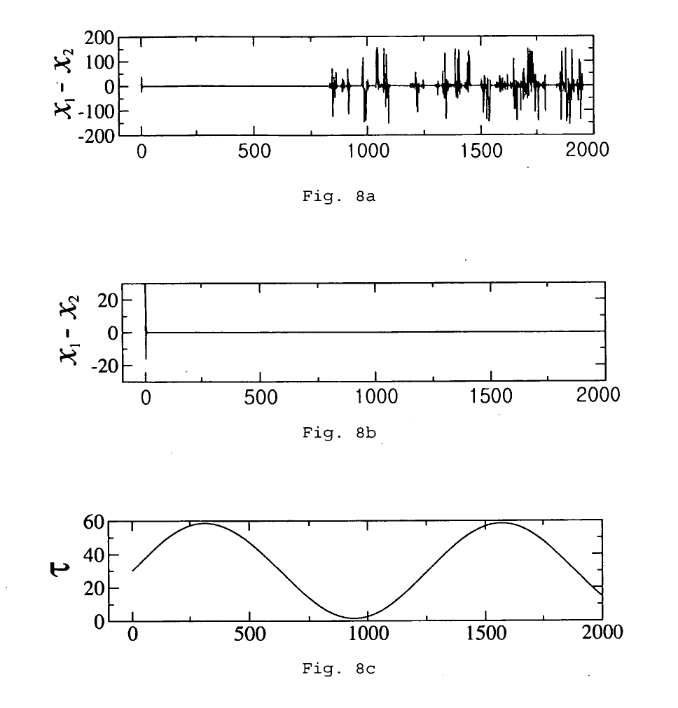

FIGS. 8a to 8c are views showing a difference between two chaotic signals obtained when two Lorenz chaotic systems are synchronized.

It is assumed that a chaotic signal of the encryption apparatus 100 is x₁, and a chaotic signal of the decryption apparatus 200 is x₂.

In this case, in a location \mathring{p} of FIG. 7 at β=0.87 and ω=0.005, included in a region in which synchronization is not realized yet, a difference between the two chaotic signals does not converge to “0” as shown in FIG. 8a. However, in a location \mathring{q} of FIG. 7 at β=0.93 and ω=0.005, included in a synchronization region, two chaotic systems are synchronized, so that a difference between the two chaotic signals converges to “0”. At this time, the waveform of modulated delay time is depicted in FIG. 8c.

Theoretical background of an encryption system and method using the above-described modulated delay time feedback chaotic signal generating apparatus of the present invention is described below using a logistic map.

Such a logistic map is given by Equation [1].
xₙ₊₁=λxₙ(1−xₙ) [1]

Equation [1] is one of the well-known equations representing chaotic behavior. Whether chaos exists is determined depending on the value of λ in Equation [1]. For example, if λ is 3.9, the first chaotic signal generating unit 110 exhibits the chaos.

In this logistic map, a signal x_{n-N} is fed back in such a way that a delay time N is modulated depending on a time to obtain N=f(t), and the modulated delay time N=f(t) is fed back to the first chaotic signal generating unit 110. At this time, if the delay time N is large, the feedback signal does not have a correlation with a chaotic signal, so that the feedback signal may become a noise signal. Further, if the noise signal is fed back to the encryption apparatus 100 and the decryption apparatus 200, the first and second chaotic signal generating units 110 and 220 can be given Equations [2] and [3], respectively,
xₙ₊₁=λ[xₙ+α(x_{n-N}−xₙ)](1−[xₙ+α(x_{n-N}−x′ₙ)]) [2]
where x_{n-N} is the feedback signal and α is a scaled magnitude,
x′ₙ₊₁=λ[x′ₙ+α(x_{n-N}−x′ₙ)](1−[x′ₙ+α(x_{n-N}−x′ₙ)]) [3]
where x_{n-N} is the feedback signal and α is a scaled magnitude.

In Equations [2] and [3], as the value of the coupling constant α for coupling the values of the feedback signal and the chaotic signal to each other is increased, the first and second chaotic signal generating units 110 and 220 are not synchronized at the initial time. However, if the coupling constant α exceeds a certain value, the first and second chaotic signal generating units 110 and 220 generate the same number later even though they have different initial values. This phenomenon is designated as chaotic synchronization.

The same value can be known by obtaining a difference equation between the above two Equations [2] and [3], which is expressed by Equation [4],
yₙ₊₁=λ(1−α)[1−2(1−α)xₙ−2αx_{n-N}]yₙ+(1−α)²y²ₙ [4]
where yₙ=xₙ−x′ₙ.

Equation [4] assumes the form of a new non-linear differential equation. However, referring to Equation [4], there are terms modulated by xₙ and x_{n-N} in the parameters of yₙ, but there is no modulated term in the parameters of y²ₙ.

Therefore, Equation [4] shows a new equation in which parameters are modulated by the variables of the chaotic signal generating units 110 and 220. In this case, all values multiplied by yₙ can be regarded as parameters. Schemes of modulating other non-linear systems using a noise signal are well known in the art.

However, if the parameters of the non-linear systems are modulated using the noise signal in this way, the chaotic signal generating units show very complicated aspects. Depending on the conditions of the respective parameters, the first and second chaotic signal generating units 110 and 220 may irregularly travel between chaotic signals and a value close to “0”, may converge to “0”, or may exhibit chaos.

Traveling between the chaos and a value close to “0” is called ON/OFF intermittency. If such intermittency occurs, the average length of Laminar flows increases infinitely, so that a threshold condition may occur in which a difference between two variables converges to “0”.

If the threshold condition is exceeded, a new chaotic signal generating unit produced by the difference between variables of the first and second chaotic signal generating units 110 and 220 directly converges to “0”. Therefore, if the difference between the variables of the chaotic signal generating units becomes “0”, there is no difference between trajectories of the first and second chaotic signal generating units 110 and 220, so that the trajectories thereof become identical to each other, that is, synchronization is realized.

In an equation having such a form, a condition in which the average length of Laminar flows becomes infinite can be theoretically obtained. That is, if the first and second chaotic signal generating units 110 and 220 are synchronized, they can be used for chaotic systems for encryption. Generally, a synchronization region is defined as a certain region, where the chaotic signal generating units can be used for the chaotic systems for encryption.

The region in which the first and second chaotic signal generating units 110 and 220 are synchronized is generated when the values of Lyapunov exponents are negative. Therefore, in the condition in which the chaotic synchronization is realized, the logistic map can be used for the encryption system.

In this method, if the delay time is modulated, the delay time does not appear in autocorrelation as shown in FIGS. 3b and 3c, so that the first and second chaotic signal generating units can be used for a secure encryption system.

The characteristics using such a synchronization method can be described using the following Lorenz equations. The Lorenz chaotic system of the encryption apparatus 100 is given by the following Equation [5].
x₁=σ(y₁−X₁)
y₁=−X₁z₁+rX₁y₁
z₁=X₁y₁−bz₁ [5]

Further, the Lorenz chaotic system of the decryption apparatus 200 is given by the following Equation [6].
x₂=σ(y₂−X₂)
y₂=−X₂z₂+rX₂−y₂
z₂=X₂y₂−bz₂ [6]

In Equations [5] and [6], σ, r and b are coefficients, which are given by 10.0, 28.0, and 8/3, respectively. Further, the feedback variable X₁ of the encryption apparatus 100 is given by X₁=(1β)x₁(t)+βx₁(t−τ), and the feedback variable X₂ of the decryption apparatus 200 is given by X₂=(1=β)x₂(t)+βx₁(t−τ), so that x₁(t−τ) is commonly fed back to the variables of the two chaotic systems.

At this time, a delay time τ is modulated to τ=0.475τ₀ sin(ωt)+τ₀/2.

In this relationship, the first and second chaotic signal generating units 110 and 220 can be synchronized. That is, as in the case of the logistic map of FIGS. 3a to 3c, two chaotic systems can be synchronized.

Then, when the Lorenz chaotic systems of the first and second chaotic signal generating units 110 and 220 are synchronized, the advantages of the characteristics of chaos emerging in the case where a delay time is modulated, compared to a case where the delay time is not modulated, are described below.

First, FIGS. 4a and 4b illustrate chaotic attractors emerging when the delay time is modulated and fed back using two Lorenz equations. When the delay time τ is modulated to τ=0.475τ₀ sin(ωt)+τ₀/2, the chaotic attractors do not have original chaotic attractors of Lorenz systems as in the case of the attractors of x-y variables and y-z variables of FIGS. 4a and 4b, respectively, where β=0.93 and ω=0.005, thus showing that the chaotic attractors are complicated high-dimensional chaotic signals.

Further, FIGS. 5a and 5b illustrate autocorrelations when two Lorenz chaotic systems are synchronized where β=0.92 and ω=0.005.

As shown in FIG. 5a, delay time information appears in the autocorrelation as it is when the delay time is fixed, so that an information signal may be detected from outside. However, if the delay time is modulated, delay time information disappears from the autocorrelation as shown in FIG. 5b, so that the delay time cannot be detected from the outside, thus enabling the Lorenz chaotic systems to be used for a secure encryption system.

At this time, as shown in FIGS. 6a and 6b, it is determined whether two Lorenz chaotic systems are actually synchronized and then used for an encryption system. In order to obtain conditions in which the two Lorenz chaotic systems are synchronized, a maximum transverse Lyapunov exponent and a secondary transverse Lyapunov exponent are obtained according to β and ω as shown in FIGS. 6a and 6b. FIGS. 6a and 6b show that a synchronization region with Lyapunov exponents having values equal to or less than “0” exists in each of the drawings.

Further, the synchronization region is obtained according to β and ω. It can be seen that there is a complete synchronization region represented by “CS” as shown in FIG. 7, so that the encryption system can be implemented due to the region.

A difference between two chaotic signals emerging when two Lorenz chaotic systems are synchronized is obtained. It is assumed that a chaotic signal of the encryption apparatus 100 is x₁, and a chaotic signal of the decryption apparatus 200 is x₂. In a location \mathring{p} of FIG. 7 at β=0.87 and ω=0.005, included in a region in which synchronization is not realized yet, a difference between the two chaotic signals does not converge to “0” as shown in FIG. 8a. However, in a location \mathring{q} of FIG. 7 at β=0.93 and ω=0.005, included in a synchronization region, the first and second chaotic signal generating units 110 and 220 are synchronized as shown in FIG. 8b, so that the difference between two chaotic signals converges to “0”. At this time, the waveform of modulated delay time is depicted in FIG. 8c.

As described above, in order to convert a simple chaotic system, such as a logistic map or Lorenz chaotic system, into a high-dimensional chaotic system, it is essential to convert the chaotic system into a delay time feedback chaotic system. However, because a delay time is fixed and fed back in a delay time feedback chaotic system which has been developed until now, there remains a problem in that the delay time is leaked and then attacks from the outside are easily attempted.

However, in the present invention, if a delay time is modulated, the trace of the delay time is removed, how long time was delayed cannot be known from the outside. Therefore, the high-dimensional characteristics of the delay time feedback chaotic system cannot be changed to low-dimensional characteristics, thus implementing a secure encryption system.

Moreover, two chaotic systems can be synchronized using such a modulated delay time feedback chaotic system, thus implementing an encryption system using the secure chaotic synchronization.

As described above, the present invention provides an encryption and communication apparatus and method using a modulated delay time feedback chaotic system, which modulates a delay time so as to prevent an information signal contained in a chaotic signal from being attacked from the outside, so that it is impossible to detect an exact delay time contained in a modulated time-delayed chaotic signal and to lower the high-dimensional chaotic system to a low-dimensional chaotic system because the delay time is modulated in a time-delayed feedback chaotic signal, and, consequently, it is impossible to decrypt the information signal, thus constructing a more robust and reliable encryption system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An encryption apparatus using a modulated delay time feedback chaotic system, comprising:
chaotic signal generating means for generating a high-dimensional chaotic signal in response to an original chaotic signal and a predetermined feedback chaotic signal;
delay time modulating means for delaying the high-dimensional chaotic signal output from the chaotic signal generating means by a predetermined time and modulating the time-delayed chaotic signal; and
feedback means for receiving the chaotic signal output from the chaotic signal generating means and the modulated time-delayed signal output from the delay time modulating means, performing addition and subtraction operations with respect to the received signals, and feeding the operated result back to the chaotic signal generating means.

2. The encryption system according to claim 1, wherein the feedback means comprises:
a subtracter for receiving the original chaotic signal output from the chaotic signal generating means and the modulated time-delayed signal output from the delay time modulating means and obtaining a difference between the received signals;
a scaling means for scaling a magnitude of the difference signal output from the subtracter to correspond to synchronization conditions; and
an adder for adding a signal output from the scaling means and the original chaotic signal output from the chaotic signal generating means to generate a predetermined chaotic signal, and feeding the chaotic signal back to the chaotic signal generating means.

3. The encryption system according to claim 1, wherein the modulating means is operated so that a delay time of the chaotic signal is modulated to a periodic signal, a semi-periodic signal, a chaotic signal or a random noise signal.

4. The encryption system according to claim 3, wherein the modulation is performed so that the delay time is modulated to the chaotic signal using a variable of a chaotic system thereof.

5. The encryption system according to claim 3, wherein the feedback means is operated so that, when the modulated time-delayed signal is fed back, the modulated time-delayed signal is fed back to a variable, a coefficient or an external force.

6. The encryption system according to claim 5, wherein the feedback is performed in such a way that a difference between the original chaotic signal and the modulated time-delayed signal is obtained by a subtracter, and the subtracted result is fed back to a variable, a coefficient or an external force by scaling means.

7. The encryption system according to claim 5, wherein the feedback is performed in such a way that the modulated time-delayed signal is directly fed back to a variable, a coefficient or an external force without change.

8. An encryption and communication apparatus using a modulated delay time feedback chaotic system, comprising:
an encryption apparatus including first chaotic signal generating means for generating a high-dimensional chaotic signal in response to a predetermined feedback chaotic signal, delay time modulating means for delaying the chaotic signal output from the first chaotic signal generating means by a predetermined time and modulating the time-delayed chaotic signal to generate a high-dimensional encryption signal, feedback means for receiving the chaotic signal output from the first chaotic signal generating means and the modulated time-delayed chaotic signal output from the delay time modulating means, performing addition and subtraction operations with respect to the two received signals and feeding the operated result back to the first chaotic signal generating means, encryption means for receiving the high-dimensional encryption signal output from the delay time modulating means and an externally-applied information signal and adding the two signals to realize encryption, and transmitting means for transmitting a signal output from the encryption means as a wireless or wired signal; and
a decryption apparatus including an receiving means for receiving the encryption signal from the transmitting means of the encryption apparatus, second chaotic signal generating means for generating a high-dimensional chaotic signal in response to a predetermined feedback chaotic signal, feedback means for receiving the encryption signal output from the receiving means and the chaotic signal output from the second chaotic signal generating means, performing addition and subtraction operations with respect to the two received signals and feeding the operated result back to the second chaotic signal generating means, delay time modulating means for receiving the chaotic signal output from the second chaotic signal generating means and modulating a delay time of the chaotic signal, and decryption means for performing a subtraction operation on the modulated time-delayed signal output from the delay time modulating means and the encryption signal output from the receiving means to realize decryption.

9. The encryption and communication apparatus according to claim 8, wherein the feedback means of the encryption apparatus includes:
a subtracter for receiving the original chaotic signal output from the first chaotic signal generating means and the modulated time-delayed chaotic signal output from the delay time modulating means and obtaining a difference between the two received signals;
scaling means for scaling a magnitude of the difference signal output from the subtracter to correspond to synchronization conditions; and
an adder for adding a signal output from the scaling means and the original chaotic signal output from the first chaotic signal generating means to generate a predetermined chaotic signal and feeding the chaotic signal back to the first chaotic signal generating means.

10. The encryption and communication apparatus according to claim 8, wherein the encryption means of the encryption apparatus is an adder.

11. The encryption and communication apparatus according to claim 8, wherein the feedback means of the decryption apparatus includes:
a subtracter for receiving the original chaotic signal output from the second chaotic signal generating means and the encryption signal output from the receiving means and obtaining a difference between the received signals;
scaling means for scaling a magnitude of the difference signal output from the subtracter to correspond to synchronization conditions; and
an adder for adding a signal output from the scaling means and the original chaotic signal output from the second chaotic signal generating means to generate a predetermined chaotic signal and feeding the chaotic signal back to the second chaotic signal generating means.

12. The encryption and communication apparatus according to claim 8, wherein the decryption means of the decryption apparatus is a subtracter.

13. The encryption and communication apparatus according to claim 8, wherein the first and second chaotic signal generating means are synchronized so as to decrypt the encryption signal.

14. An encryption and communication method using a modulated delay time feedback chaotic system, comprising the steps of:
generating a chaotic signal by a chaotic system in which variables are functionally connected and a delay time is modulated;
encrypting an externally-applied information signal by adding the information signal to the chaotic signal, the delay time of which is modulated, thus generating an encryption signal;
transmitting the encryption signal;
receiving the encryption signal and feeding the encryption signal to a predetermined chaotic system;
receiving the chaotic signal output from the chaotic system and modulating a delay time of the chaotic signal; and
comparing the modulated time-delayed chaotic signal to the received encryption signal and then extracting the information signal, thus decrypting the encryption signal.
